(19) United States
(12) Patent Application Publication
(10) Pub. No.: US 2006/0281446 A1
(43) Pub. Date: Dec. 14, 2006

(54) Method for downloading documents by using multimedia messaging of wireless communication device

(75) Inventors: Cheng-Shing Lai, Taipei (TW); Jing-Song Wu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliance Corp., Taipei (TW)

(21) Appl. No.: 11/136,571

(22) Filed: May 25, 2005

(51) Int. Cl. H04M 3/00

(52) U.S. Cl. 455/418

(57) ABSTRACT

The present invention is to provide a method for downloading documents by using multimedia messaging of a wireless communication device, which employs a personal computer to connect with Internet and to send and receive multimedia messages, wherein the multimedia messages to be sent and received are represented as downloaded documents by using the simultaneous media integration language, and are transmitted to a designated wireless communication device via a network server. The wireless communication device recognizes that the multimedia message being received is a downloaded document and sends out a response to the network server, and then stores or displays the downloaded document.

### FIELD OF THE INVENTION

The present invention relates to a method for downloading documents by using multimedia messaging of a wireless communication device, and more particularly to a method for sending multimedia messages via Internet by personal computer. The multimedia messages to be sent are represented as downloaded documents and then transmitted to a designated wireless communication device via a network server to achieve the goal of downloading document.

### BACKGROUND OF THE INVENTION

The contemporary world has experienced a booming development of information technology and electronic industry contemporary. Many high-tech products, mobile communication products and network communication technologies evolved from the computer technology have become smaller and smaller in size with more and more functions included therein, and yet cheaper and cheaper in price, making them become more and more popular. In particular, the most commonly seen mobile phone and personal digital assistant (PDA), which are closest to our daily life, have been widely adopted to shrink down the spatial and temporal separations between people. Since more and more kinds of communication products have been developed to replace the old ones, the consumers are demanding more and more functions to be integrated into one communication product. Therefore, the ability to provide a more convenient, more efficient communication product with more and more functions and services integrated therewith has become the most important indication of whether the manufacturer thereof can lead the market.

Currently, one method for downloading documents from the network is using a wireless communication by a personal computer to download the document first from the network. Then, the personal computer is connected with the wireless communication device, so as to transmit the downloaded document from the personal computer to the wireless communication device. Another method is using the wireless communication device to connect to the network to download the document directly. However, the method that using a personal computer to download documents requires the personal computer which installs a connection software, so as to connect with the wireless communication device. Therefore, such an inapplicable method is only useful for some personal computers which install within such connection software.

On the other hand, since the connection speed of downloading a document from network to the wireless communication device is rather slow, the method that downloads documents from the network directly using the wireless communication device will take too much time, which is also very inconvenient.

### SUMMARY OF THE INVENTION

In light of the drawbacks of the conventional methods described above, the inventors of the present invention has studied and experimented all possible solutions thereof, and finally developed a method for downloading documents by using multimedia messaging of a wireless communication device, so as to enhance the document download speed of the wireless communication device.

It is an object of the present invention to provide a method for downloading documents by using multimedia messaging of a wireless communication device. The method employs a personal computer that is connected with the Internet to send out multimedia messages. The multimedia messages to be sent are then represented as a downloaded document by using the simultaneous multimedia integration language (SMIL). The multimedia messages are then transmitted to a designated wireless communication device via a network server. After the multimedia messages are received in the wireless communication device, a pre-configured recognizer is used to recognize that the multimedia messages are the downloaded document, and sends out a response to the network server. In this manner, the downloaded document can be stored in the wireless communication device, or displayed on the wireless communication device. The purpose of rapidly downloading documents by using the multimedia messaging is thus achieved.

It is another object of the present invention to provide a method to calculate the network usage fee. After the network server receives the response, the network server can then calculate the appropriate fee for network usage based on the type and size of the downloaded document.

The above and other objects, features and advantages of the present invention will become apparent from the following detailed description taken with the accompanying drawings.

### BRIEF DESCRIPTION OF THE DRAWINGS

FIG. 1 illustrates a structure diagram of the present invention.

FIG. 2 illustrates a block diagram of a wireless communication device of the present invention.

FIG. 3 is a flow diagram illustrating the process for receiving documents, in accordance with the present invention.

FIG. 4 is a flow diagram illustrating the process for sending documents, in accordance with the present invention.

### DETAILED DESCRIPTION OF THE PREFERRED EMBODIMENTS

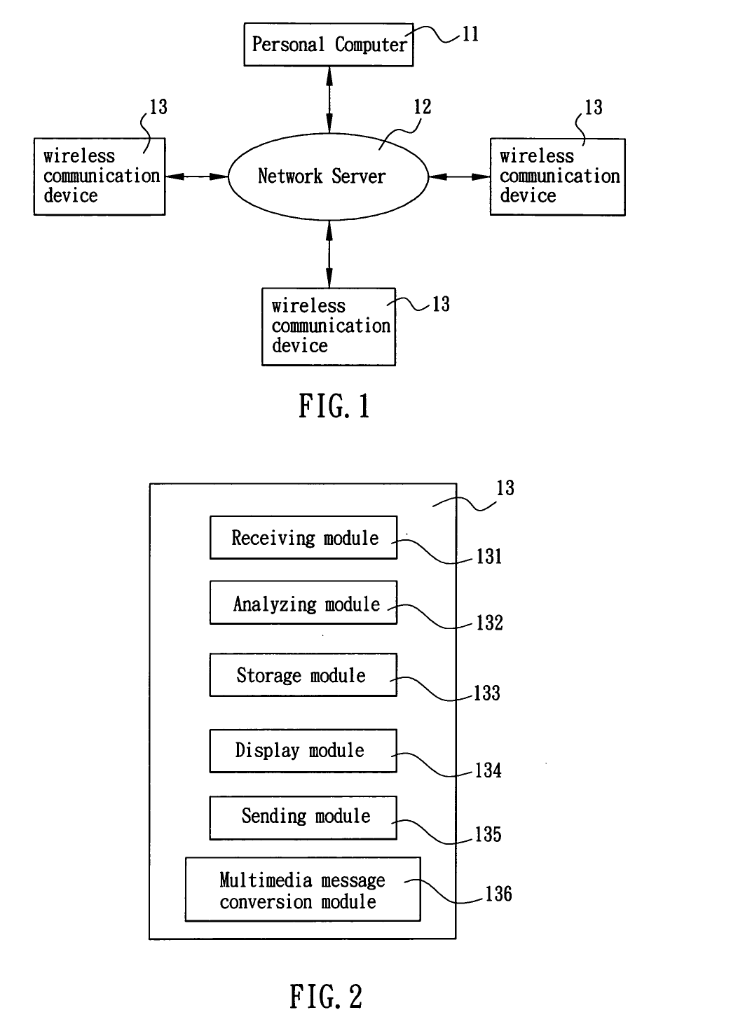

The present invention provides a method for downloading documents by using multimedia messaging of wireless communication device. Referring to FIG. 1, the method employs a personal computer 11 connected with the Internet to send multimedia messages (MMS). The multimedia messages to be sent are represented as download documents by using the simultaneous media integration language (SMIL). Then, the multimedia messages are sent to a designated communication device 13 through a network server 12. After the multimedia messages are received in the wireless communication device 13, a pre-configured recognizer is used to recognize that the multimedia messages are the downloaded document, and sends out a response to the network server 12. In this manner, the wireless communication device 13 can store the downloaded document, or display the downloaded document, thereby achieving the purpose and effect of rapidly downloading documents via multimedia messaging.

Referring again to FIG. 1, after the response of the wireless communication device 13 is received by the network server 12, the network server 12 will calculate the fees to be charged for using the network in accordance with the information, such as the type and the size of the downloaded document, contained in the response.

Referring to FIG. 1 and FIG. 2, the circuit of the wireless communication device 13 includes a receiving module 131, an analyzing module 132, a storage module 133, a display module 134, a sending module 135, and a multimedia message conversion module 136. The receiving module 131 receives the MMS sent from the network server 12. The analyzing module 132 comprises a recognizer (not shown) which enables the analyzing module 132 to recognize the MMS sent from the network server 12. The storage module 133 comprises a memory (such as flash memory, not shown) which enables the storage module 133 to store the downloaded document. The display module 134 comprises a screen (such as Liquid Crystal Display not shown) which enables the display module 134 to display the downloaded document for users to browse the document. The sending module 135 can send the downloaded document to other wireless communication devices 13. The multimedia message conversion module 136 can also convert the document in the wireless communication device 13 into MMS that contains downloaded information. The sending module 135 can then send the message to other wireless communication devices 13.

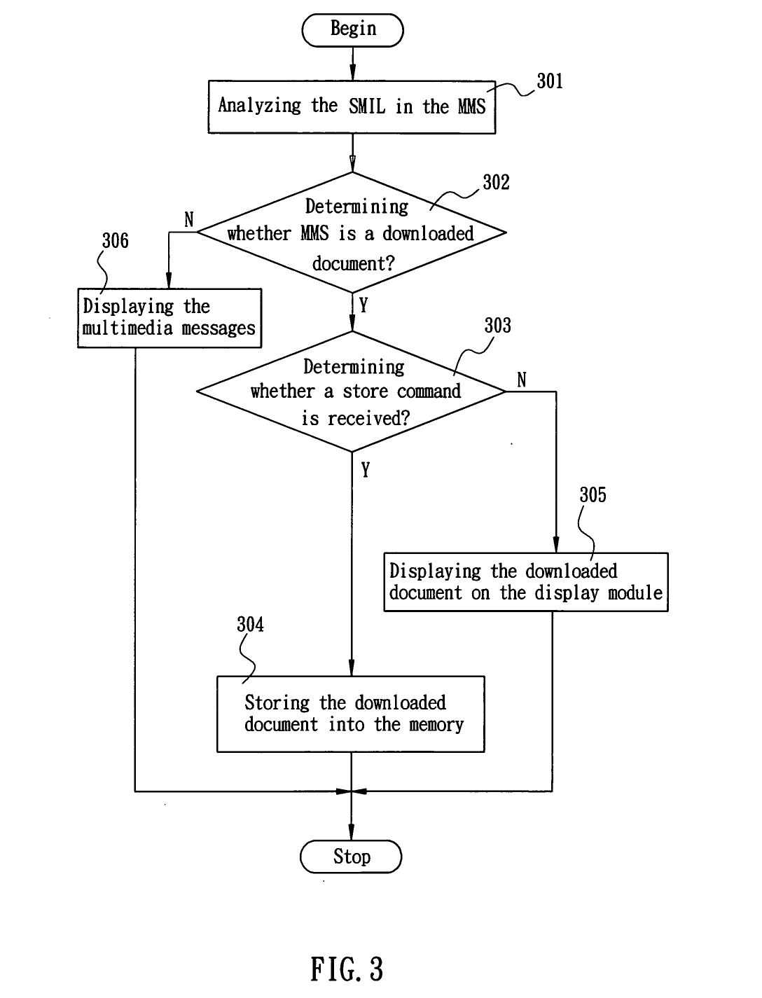

Referring to FIG. 1 and FIG. 3, the wireless communication device 13 performs the following steps when the MMS sent from the network server 12 is received by the wireless communication device 13:

First at all in step 301, the recognizer recognizes the SMIL in the MMS.

Step 302, determines whether the MMS is a downloaded document according to the recognized information. If yes, continue to go to step 303, otherwise, go to step 306.

Step 303, determines whether a store command is received from the user. If yes, continue to go to step 304, otherwise, go to step 305.

Step 304, stores the downloaded document into the memory, and then stop.

Step 305, the downloaded document is displayed on the display module 134 for users to browse the document, and then stop.

Step 306, displays the multimedia message, and then stop.

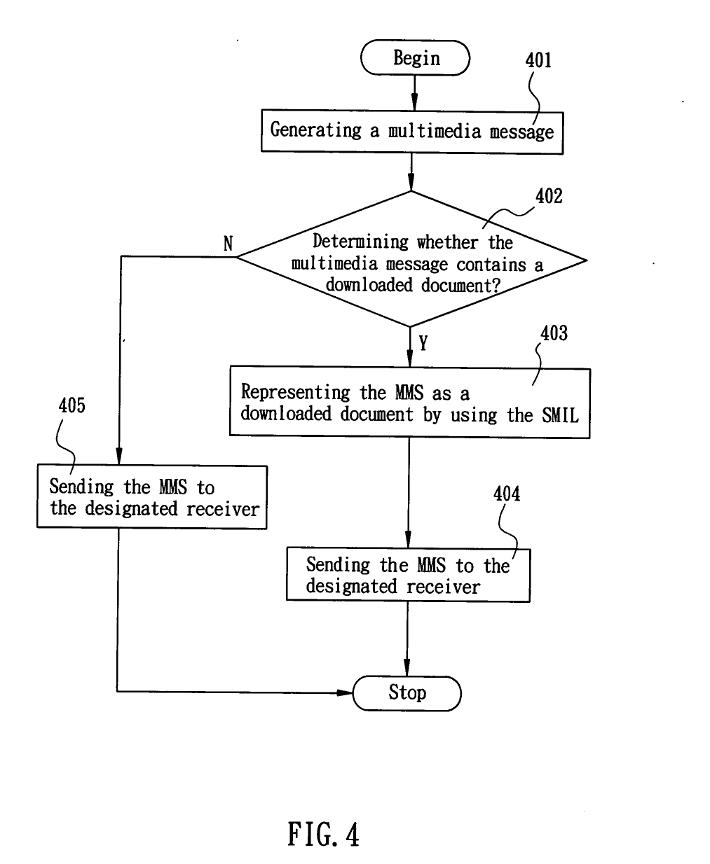

Referring to FIG. 1 and FIG. 4, when the MMS is sent out to the Internet via the personal computer 11, the personal computer 11 performs the following steps:

First, in step 401, a multimedia message is generated according to the input information or command.

Step 402 determines whether the multimedia message contains a downloaded document. If yes, continue to go to step 403, otherwise, go to step 405.

In step 403, the MMS is represented as a downloaded document by using the SMIL.

In step 404, the MMS is sent to the designated receiver, and then stop.

In step 405, the MMS is sent to the designated receiver, and then stop. According to one particular embodiment of the present invention, the SMIL comprises a label of “<!-- -->”. Such a label is employed to give comments to the multimedia message, thereby commenting that the MMS is a downloaded document, adding ^{┌}download_{┘} into the label. For example, the label “<!--LACN_MMS MPG DOWNLOAD-- >” denotes that this is an MMS containing downloaded contents. Furthermore, one can use the label “<!--LACN_MMS_FIEL_OEBsrc=“sample.oeb-- >” to tell the recognizer of the wireless communication device 13 that this document contains a document “sample.oeb”, which is to be downloaded. While the invention has been described by means of specific embodiments, numerous modifications and variations could be made thereto by those skilled in the art without departing from the scope and spirit of the invention set forth in the claims.

What is claimed is:

1. A method for downloading documents by using multimedia messaging of a wireless communication device, the method employs a personal computer to connect with Internet and to send and receive multimedia messages, wherein the multimedia messages to be sent and received are represented as downloaded documents by using the simultaneous media integration language, and are transmitted to a designated wireless communication device via a network server;
whereby a recognizer pre-configured in the wireless communication device recognizes that the multimedia message is the downloaded document after the multimedia message is received in the wireless communication device, and sends out a response to the network server, thereby storing the downloaded document in the wireless communication device or displaying the downloaded document on the wireless communication device.

2. The method of claim 1 wherein the network server calculates the network usage fee based on the content and size of the document recorded in the response, after the network server receives the response from the wireless communication device.

3. The method of claim 1, wherein the circuit of the wireless communication device comprises a receiving module, an analyzing module, a storage module, a display module, a sending module and a multimedia message conversion module, wherein the receiving module receives the multimedia messages sent from the network server, the analyzing module comprises the recognizer that recognizes the multimedia messages sent from the network server, the storage module comprises a memory which stores the downloaded document, the display module displays the downloaded document for users to browse the document, the sending module sends the downloaded document to other wireless communication devices, the multimedia message conversion module converts the document in the wireless communication device into multimedia messages that contains download information, and then the sending module sends this message to other wireless communication devices.

4. The method of claim 3 wherein the memory comprises a flash memory.

5. The method of claim 3 wherein the display module comprises a liquid crystal display.
